(19) United States
(12) Patent Application Publication
(10) Pub. No.: US 2013/0228940 A1
(43) Pub. Date: Sep. 5, 2013

(54) Spray Device to be Mounted on an Electric Vehicle

(71) Applicants: Chan Yong Ahn, Gyeonggi-Do (KR); Rye Soon Lee, Gyeonggi-Do (KR)

(72) Inventors: Chan Yong Ahn, Gyeonggi-Do (KR); Rye Soon Lee, Gyeonggi-Do (KR)

(21) Appl. No.: 13/884,197

(22) PCT Filed: Nov. 3, 2011
(86) PCT No.: PCT/KR2011/008330

§ 371 Date: May 8, 2013

(30) Foreign Application Priority Data
Nov. 9, 2010 (KR) 10-2010-0111029

(51) Int. Cl. B01D 47/06

(52) U.S. Cl. CPC B01D 47/06
USPC 261/34.1

(57) ABSTRACT

A spray device mounted on a non-motor vehicle (T-car) selected from among commercial or novel electric vehicles so as to improve air quality inside a tunnel by spraying water during operation, collecting pollutants floating inside a subway tunnel, and collecting and sinking fine dust generated by means of the operation of a train onto the road. The spray device is mounted on a lower portion of the non-motorized vehicle (T-car) from among commercial or new electromotive cars, pressurized water is supplied to a distribution pipe on a discharging side by means of a pressurizing motor and a pump, and a jet is sprayed through a spray nozzle coupled to the distribution pipe. Also, it is possible to automatically spray a jet onto a rail surface while a train moves on a ground-level railway using a sensor and a control board.

### CROSS-REFERENCE TO RELATED APPLICATION

This application claims the benefit of Korean Patent Application No.10-2010-0111029, filed on Nov. 9, 2010 in the Korean Intellectual Property Office, the disclosure of which is incorporated herein by reference.

### TECHNICAL FIELD

The present invention relates to a spray device to be mounted on an electric vehicle, and more particularly, to a spray device which is mounted on as trailer car (T-car) in a commercial or novel electric vehicle in order to spray water while the electric vehicle is driving, so that the water collects pollutants floating in an underground tunnel as well line dust created during operation of a train and sinks the pollutants and fine dust to the road, thereby significantly improving the quality of air inside the tunnel.

### BACKGROUND ART

At present, the actual state of air pollution in underground tunnels and underground stations has reached a severe level. in order to overcome this, organizations which run the subway are temporarily decreasing the concentration of fine dust at platforms of underground stations by constructing screen doors on the platforms. However, the level of pollution inside the tunnels is rather increasing. According to the characteristic of the fine dust of flowing from a high-concentration area to a low-concentration area, the fine dust is absorbed into passenger cars of an electric train which is being operated or enters the platforms of the stations, thereby threatening the health of passengers.

In addition, several types of water spraying equipment have been developed in order to improve the air environment inside the subway tunnels. However, it is impossible to input a spraying Vehicle mounted with expensive spray equipment to underground main lines because of frequent operation of electric vehicles at their service times. Therefore, the spraying equipment is useless even though it employs advanced technology. Since spraying work must be carried out when the subway is not in service, the distance at which the spraying is carried out must be limited compared to the total extension distance of lines. Therefore, the use of the spray equipment is not effective considering its expensive purchase price.

In addition, ground rails in the daytime having the greatest amount of sunshine in the summer undergo a significant rise in temperature since the urban heat island phenomenon is intensified due to a variety of ground constructions, such as soundproofing walls, and radiation heat. If the rails are not cooled down, they may be subjected to bucking, i.e. they may come off upward or warp to the side, thereby consequently leading to an accident of derailment of a train.

For reference, the provision of Article 40 of the Regulations of High-Speed Railway Operation requires careful driving (230 km/h) when the rail temperature is close to 55° C. (at an air temperature of 32° C.), slow driving (70 km/h) when the rail temperature is close to 60° C., and service pending or stop when the rail temperature is 64° C. or higher.

Since the rails are made of steel that is sensitive to temperature as described above, they elastically respond to heat and easily expand at a high temperature of 50° C. or higher. Therefore, there is a risk of accidents such as derailment at a curved section. In addition, the use of continuous welded rails (CWRs), joints of which are welded to each other to a length typically ranging from 1000 m to 2000 m, is increasing in order to provide a comfortable service, thereby also increasing the length of the rails that expand. Accordingly, a technology that can prevent rail bucking in the summer is required.

In order to overcome these problems, Korean Patent Application No. 2008-0028193 (titled “THE SPRINKLER SYSTEM WHICH AFFIXES IN THE ELECTROMOTIVE CAR) by the applicant was disclosed and patented.

The previously filed patent is configured such that water can be sprayed to the road of an underground tunnel or to ground rails during the hot season of summer. However, a trainman is required to operate the spray device after manipulating a spray switch in order to spray water to the ground rails. Therefore, the trainman may become careless about his own task pertaining to safe driving of the train. In addition, it is required that cars furnished to one electric vehicle, ranging from a trailer car (T-car) on which the spray device is mounted to a switch inside a front or rear locomotive, be connected via control wires. Therefore, during a shunting operation (an operation of newly adding a passenger/carriage car to a train or changing a passenger/carriage car in a train) or when cars furnished to one vehicle are to be separated from or coupled to each other, it is also required to necessarily separate or couple the control wires.

Furthermore, since a water supply port is disposed at one side of the spray device, it is difficult to supply water to an electric vehicle at a platform of a specific subway station when the electric vehicle is being stored at the subway station for the first service in the next day after finished operation.

### DISCLOSURE

### Technical Problem

The present invention has been made to solve the foregoing problems with the prior art, and therefore an object of the present invention is to provide a spray device mounted on an electric vehicle, which can detect a temperature around rails in real time using a sensor while the electric vehicle is driving, and when the detected temperature is equal to or higher than a set temperature, automatically operate to concentrically spray water to the surface of the rails through spray nozzles, which are directly above the rails, thereby cooling down the temperature of the rails. It is therefore possible to prevent an accident of derailment of a train which would otherwise be caused by bucking in which the rails come off upward or warp to the side. In addition, the spray device according to the invention can be widely applied to not only urban subway systems, but also regional railway lines, industrial railway lines, high-speed railway lines and the like, in which rails are watered by mobilizing manpower at every section when the temperature around rails is equal to or higher than a predetermined temperature.

Another object of the present invention is to provide a spray device mounted on an electric vehicle, which atomizes and sprays water so that fine water particles can collect fine dust and harmful matters floating in the air and sink the fine dust and harmful matters to the road, thereby significantly improving the quality of air inside a subway tunnel. In addition, water particles which are finely atomized can obtain a cooling effect due to the heat of evaporation, thereby improving the condition of air inside the subway tunnel in the summer.

### Technical Solution

According to an aspect of the present invention, provided is a spray device mounted on a trailer car (T-car) in a commercial or novel electric vehicle. Pressurized water is supplied to distribution pipes at a discharge side using a compression motor and a pump, and is atomized and sprayed through spray nozzles coupled to the distribution pipes.

Also provided is a spray device mounted on a trailer car (T-car) in a commercial or novel electric vehicle. The spray device includes, preferably, a sensor and a control panel, such that water can be automatically sprayed to the road of a subway tunnel while a train is driving.

Furthermore, according to the invention, a water supply port is disposed at one side of a doorway of the trailer car (T-car) on which the spray device is mounted, such that the water supply tank can be supplied with water using a water supply gun at a platform of a subway station when the electric vehicle is staying at a specific station for the first service in the next day. In addition, vertical partition plates are provided inside the water supply tank in order to minimize the water inside the water supply tank sloshing back and forth and to the left and right when the electric vehicle suddenly brakes due to as sudden stop or an unexpected situation during driving.

### Advantageous Effects

According to the invention, it is possible to prevent an accident of derailment of a train which would otherwise be caused by bucking in which the rails come off upward or warp to the side. In addition, the invention can be widely applied to not only urban subway systems, but also regional railway lines, industrial railway lines, high-speed railway lines and the like, in which rails are watered by mobilizing manpower at every section when the temperature around rails is equal to or higher than a predetermined temperature.

In addition, water is atomized and sprayed so that line water particles can collect fine dust and harmful matters floating in the air and sink the fine dust and harmful matters to the road, thereby significantly improving the quality of air inside a subway tunnel. In addition, water particles which are finely atomized can obtain a cooling effect due to the heat of evaporation, thereby improving the condition of air inside the subway tunnel.

### DESCRIPTION OF DRAWINGS

FIG. 1 is a front elevation view of a typical trailer car (T-car) in an electric vehicle;

FIG. 2 is a front elevation view of the typical trailer car (T-car) in the electric vehicle on which a spray device according to the invention is mounted;

FIG. 3 is a perspective view of an outer housing of the spray device according to the invention;

FIG. 4 is a perspective view of a water supply tank of the spray device according to the invention;

FIG. 5 is a detailed perspective view of the spray device according to the invention; and

FIG. 6 is a use state view of the spray device according to the invention.

### BEST MODE

Reference will now be made in detail to an exemplary embodiment of the present invention, examples of which are illustrated in the accompanying drawings and described below.

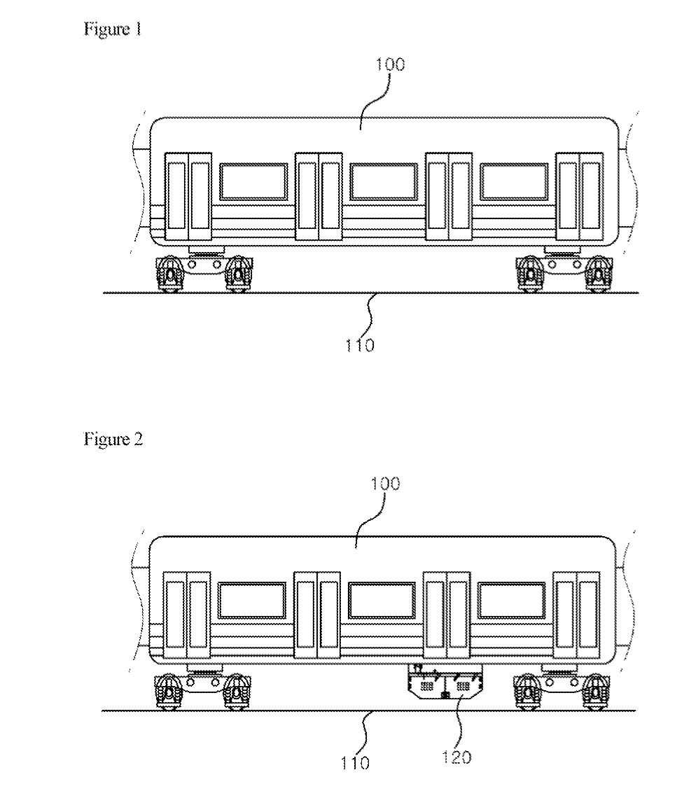

FIG. 1 is a front elevation view of a typical trailer car (T-car) in an electric vehicle.

As shown in the figure, the trailer car (T-car) in the electric vehicle 100 has a marginal space between the underside thereof and rails 110, since neither a power unit nor a control with is disposed on the underside.

FIG. 2 is a front elevation view of the typical trailer car (T-car) in the electric vehicle on which a spray device according to the invention is mounted.

As shown in the figure, the spray device 120 according to the invention can be mounted on the underside of the trailer car (T-car) having the marginal space in the electric vehicle 100 such that it has a variety of shapes. The spray device 120 is mounted on a new electric vehicle at the stage of fabricating the electric vehicle.

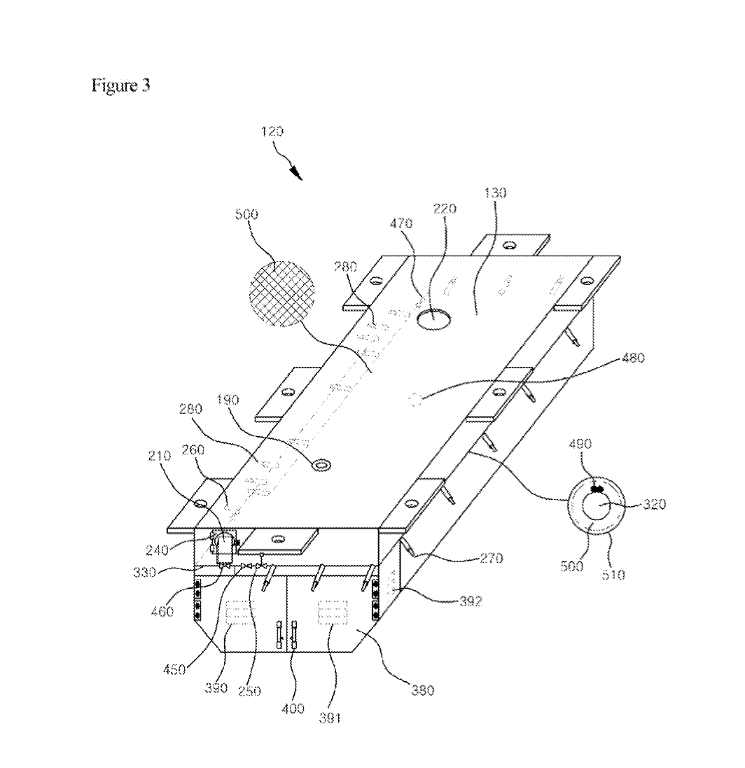

FIG. 3 is a perspective view of an outer housing of the spray device according to the invention.

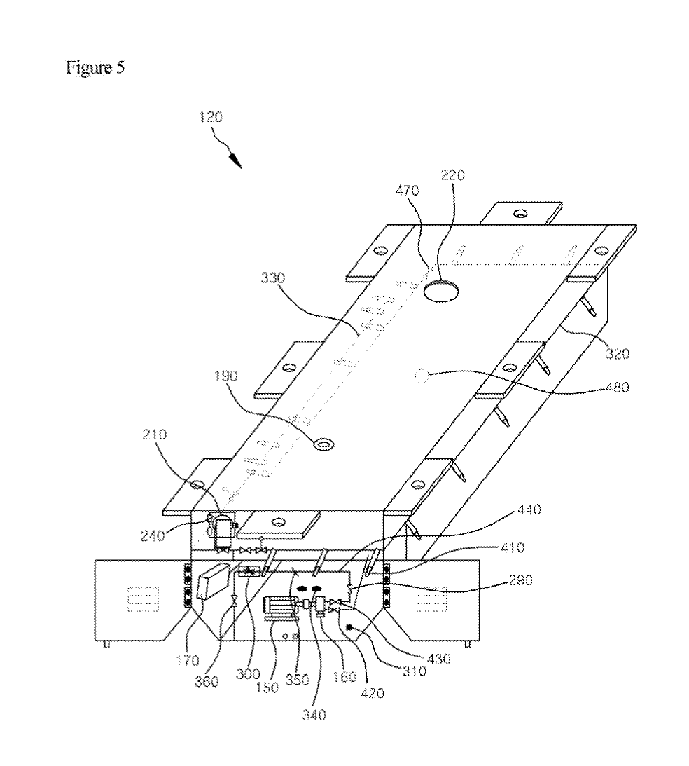

As shown in the figure, in order to protect a compression motor 150 and a pump 160, which create pressurized water from water, and other components shown in FIG. 5, these components are disposed inside one side of the spray device 120, which is partitioned using a gate 380. Grill boards 390, 391 and 392 each of which includes a grill and a closed surface are provided on both sections of the gate 380 and on a side of the spray device 120.

In order to block external air, the outer housing of the spray device 120 is covered with a heat-retaining insulation material 500. Heat-generating elements 490 are disposed along distribution pipes 320 and 330 outside the distribution pipes 320 and 330. The distribution pipes 320 and 330 and the heat-generating elements 490 are wrapped in the heat-retaining insulation material 500 and a heat-retaining insulation material cover 510.

Accordingly, the invention can be put into practice in order to improve the quality of an in an underground tunnel throughout the year irrespective of temperature.

In addition, a water supply port 210 disposed in one surface of the spray device 120 has a water supply port cover 240. The water supply port cover 240 has a hollow portion which extends from the central portion of the contact surface which closely adjoins the water support port 210 to the downward protruding end such that the water can be discharged to the outside when the supplied water reaches or exceeds a high-water level. Consequently, the water supply tank 130 slays under the atmospheric pressure. One side of the water supply port cover 240 is coupled to the water supply tank 130 via a hinge, and the other side of the water supply port cover 240 forms a latch, which is fixedly fastened to a latch hole of the spray device 120.

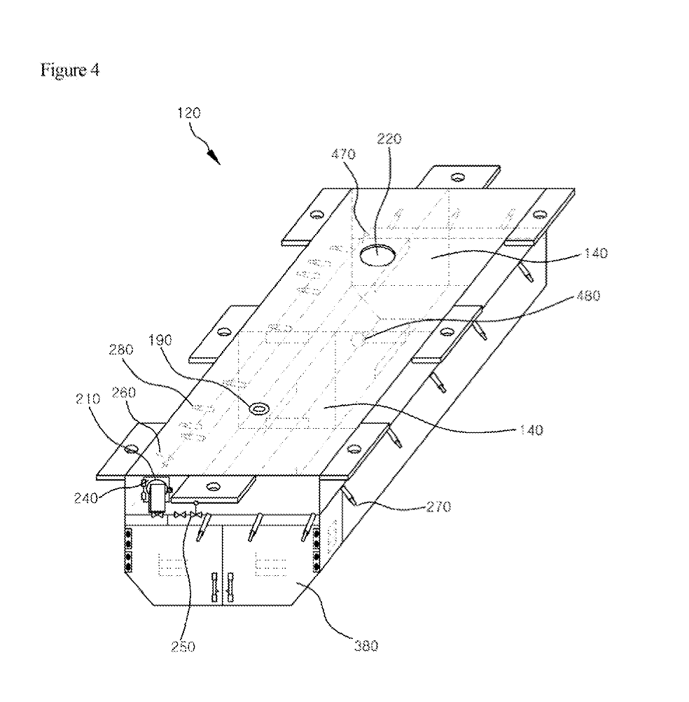

FIG. 4 is a perspective view of the water supply tank of the spray device according to the invention.

The water supply ports 210 and 220 are formed at one side of and the upper portion of the spray device 120. The water supply port 220 formed in the upper portion of the spray device 120 is configured such that it can be connected to a water supply port 230 which is formed at one side of a doorway of the trailer car (T-car) on which the spray device 120 is mounted. The water supply port 210 formed in one side of the spray device 120 is provided with the water supply port cover 240, which has a hollow portion which extends from the central portion of the contact surface which closely adjoins the water support port 210 to the downward protruding end. One side of the water supply port cover 240 is coupled to the spray device 120 via the hinge, and the other side of the water supply port cover 240 is fixedly fastened to the latch hole of the spray device 120 via the latch.

A level sensor 190 for detecting the level of the water inside the water supply tank 130 is provided in the upper portion of the spray device 120. The compression motor 150 and the pump 160 operate when the level sensor 190 detects a water level that does not exceed the low-water level. When the water supplied to the water supply tank 130 caches or exceeds the high-water level, a buzzer (not shown) operates.

In addition, a drain valve 480 is disposed in the central portion of the bottom of the water supply tank 130.

In addition, vertical partition plates 140 are provided in the lateral and longitudinal directions inside the water supply tank 130 in order to minimize the water inside the water supply tank 130 sloshing back and forth and to the left and right when the electric vehicle 100 suddenly brakes due to a sudden stop or an unexpected situation during driving. The upper and lower ends of the partition plates 140 are perforated at a plurality of positions in order to facilitate the movement of the air and water.

FIG. 5 is a detailed perspective view of the spray device according to the invention.

The spray device 120 has a control and 170 which receives signals from the water supply tank 130 which stores the water therein, the compression motor 150 and the pump 160 which supply the pressurized water, and a variety of sensors, and controls the compression motor 150 and the pump 160. When spraying conditions are satisfied, by the control panel 170, automatic valves 250 and 260 are opened and, at the same time, the compression motor 150 and the pump 160 start operating, thereby supplying the pressurized water to spray nozzles 270 and 280, which in turn atomize and spray the water.

The spraying conditions under which the spray device 120 operates on the road of the subway tunnel indicate situations in which a sensor (not shown) for detecting the operation of the electric vehicle and a sensor (not shown) for detecting an underground tunnel structure detect their targets and the level sensor 190 detects that the level of the water stays equal to or higher than the low-water level. When the spraying conditions are satisfied, the automatic valve 250 is opened and the compression motor 150 and the pump 160 operate, so that the pressurized water is sprayed to the road and the both sides of the underground tunnel through the spray nozzles 270.

At this time, the level sensor 190 sends a water level state signal about the supply tank 130 to a control unit (not shown) which is disposed on the control unit 170. When the water level of the water supply tank 130 is equal to or higher than the low-water level, the control unit (not shown) determines that some of the spraying conditions for the operation of the spray device 120 are satisfied.

According to the above-described spraying conditions, when the water level of the water in the water supply tank 130 is equal to or lower than the low-water level of the level sensor 190 during the operation of the spray device 120, or when the electric vehicle has stopped at a subway station or in a subway tunnel, the control panel 170 switches off power to the automatic valve 250 and the compression motor 150 so that the spray device 120 stops operating.

In addition, the spraying conditions under which the splay device 120 operates on the ground rails in the summer require that the temperature around the rail detected by the temperature sensor 310 protruding from the underside of the spray device 120 is equal to or higher than a set temperature and that the water level detected by the level sensor 190 stays equal to or higher than the low-water level. When these spraying conditions are satisfied, the spray device 120 operates to concentrically spray the water to the surface of the rails.

Even though the spray device 120 is operating under the spraying conditions, if the water level of the water supply tank 130 is equal to or lower than the low-water level of the level sensor 190 or the temperature sensor 310 does not operate, the control panel 170 switches off power to the automatic valve 260 and the compression motor 150, thereby stopping the operation of the spray device 120.

The distribution pipes 320 and 330 are divided into a distribution pipe for spraying the water to the road in the subway tunnel and a distribution pipe for spraying the water to the surface of the ground rails. A branch valve 450 and an automatic valve 250 are coupled to the distribution pipe 320 for spraying the water to the upper surface of the road and both sides of the subway tunnel, the spray nozzles 270 are coupled to the inclined surface of the distribution pipe 320, and a selection valve 470 is provided at a predetermined point of the distribution pipe 320.

In addition, a branch valve 460 and an automatic valve 260 are coupled to the distribution pipe 330 for spraying the water to the surface of the ground rails, and the spray nozzles 280 are coupled to one surface of the distribution pipe 330.

In addition, a suction pipe 410 connected to the pump 160 is provided with a suction valve 420, and a discharge pipe 440 connected to the pump 160 is provided with a pressure adjustment valve 300, a discharge valve 430, a check valve 290, strainer 350 and a drain valve 360.

Here, the pressure adjustment valve 300 disposed in the discharge pipe 440 is configured such that it can adjust the pressure of the pressurized water supplied by the compression motor 150 and the pump 160 to a suitable pressure so that the pressurized water can collect fine dust floating in a wide range on the road of the tunnel when sprayed through the spray nozzles 270 and 280.

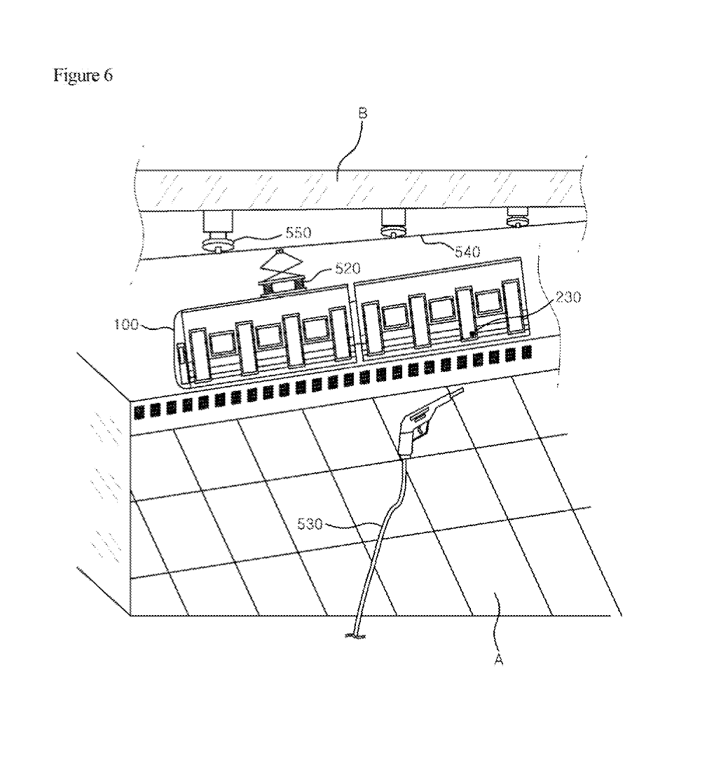

It is preferred that the water supply port 230 disposed at one side of a doorway of the trailer car (T-car) in the electric vehicle 100 be connected to the water supply port 220 at the upper side of the spray device 120 via a hollow guide pipe such that it can be easily supplied with water via a water supply gun 530 at a platform A in the subway station shown in FIG. 6.

When the water is supplied at the subway station platform A, the level sensor 190 and the control unit (not shown) interwork with each other, so that the buzzer (not shown) operates when the level of the supplied water inside the water supply tank 130 becomes equal to or higher than the high-water level. When the supplied water exceeds the high-water level, an excessive amount of the water is discharged to the outside via a hole in the water supply port cover 240. The drain valve 480 is disposed in the central portion of the bottom of the water supply tank 130.

In addition, a water level window (not shown) which indicates the amount of water inside the water supply tank 130 is disposed in one side of the spray device 120.

In addition, a heater unit 340 is provided for use during cold winters. With the heater unit 340, the water can be sprayed to the upper surface of the road and the both sides of the subway tunnel throughout the year. The heater unit 340 operates when the temperature of the external air is equal to or lower than a set temperature, and the level of the water detected by the level sensor 190 stays equal to or higher than the low-water level.

Reference numeral 400, which has not been referred to, is a lock bracket which is used for closing the doorway.

FIG. 6 is a use state view of the spray device according to the invention, in which the water is supplied to the water supply tank 130 at a platform A of a subway station.

When the electric vehicle 100 is staying at a specific station for the first service in the next day, the water supply tank 130 is supplied with water via the water supply port 230 disposed at one side of a doorway of the trailer car (T-car), which is a part of the electric vehicle and on which the spray device 120 is mounted, using the water supply gun 530 at the platform A of the subway station.

With respect to reference numerals which have not been described, 520 indicates a pantograph which receives power from an overhead wire 540 for the electric vehicle, 540 indicates the overhead wire, 550 indicates insulators of the overhead wire, and B indicates the ceiling.

The foregoing embodiments of the invention have been presented for the purposes of illustration. They are not intended to limit the technical concept or scope of the invention. It should be understood that all changes and variations that a person having ordinary skill in the art can easily devise fall within the scope of the invention.

### INDUSTRIAL APPLICABILITY

The invention can be widely applied to not only urban subway systems, but also regional railway lines, industrial railway lines, high-speed railway lines and the like, in which rails are watered by mobilizing manpower at every section when the temperature around rails is equal to or higher than a predetermined temperature.

1. A spray device which is mounted on an electric vehicle in order to improve air quality in a subway tunnel, the spray device comprising:
a water supply port disposed at one side of a doorway of a trailer car (T-car) on which the spray device is mounted, the water supply port being supplied with water using a water supply gun at a platform (A) of a subway station;
a water supply tank which contains the water therein, the water supply tank having partition plates therein;
a compression motor and a pump which supply pressurized water to the spray device;
distribution pipes which guide the pressurized water so that the pressurized water is automatically sprayed to a road and both sides of the subway tunnel and to a surface of ground rails;
spray nozzles disposed in the distribution pipes to spray the pressurized water to the road and both sides of the subway tunnel and to the surface of ground rails;
a pressure adjustment valve for adjusting the pressurized water supplied to the spray nozzles to a proper pressure;
automatic valves disposed on the distribution valves at front ends of the spray nozzles; and
a control panel which controls the automatic valves, the compression motor and the pump based on operations of a plurality of sensors and a control unit which are provided in the spray device,
wherein the spray device operates in real time to spray the pressurized water through the spray nozzles by supplying the pressurized water through the automatic valves and the distribution pipes while the electric vehicle is driving.

2. The spray device of claim 1, wherein the plurality of sensors include a temperature sensor protruding from a lower portion of the spray device, the temperature sensor detecting a temperature around rails, and a level sensor which detects a water level inside the water supply tank, wherein, when the temperature around the rails detected by the temperature sensor is equal to or higher than a set temperature and the water level detected by the level sensor stays equal to or higher than a low-level, the spray device operates in response to an operation of the control panel to concentrically spray the pressurized water to the surface of the ground rails.

3. The spray device of claim 1, wherein the plurality of sensors include a sensor which detects an operation of an electric vehicle, a tunnel structure sensor which detects a tunnel structure, and a level sensor which detects a water level inside the water supply tank, wherein, when the operation of the electric vehicle is detected and the tunnel structure is detected and the water level detected by the level sensor stays equal to or higher than a low-level, the pressurized water is automatically sprayed in real time in response to the operation of the control panel to the surface and the both sides of the ground rails while the electric vehicle is driving.

4. The spray device of claim 1, wherein the partition plates are provided in lateral and longitudinal directions inside the water supply tank, and upper and lower ends of the partition plates are perforated at a plurality of positions in order to facilitate movement of air and water.

5. The spray device of claim 1, wherein the water supply port and a water supply port formed at an upper side of the spray device is connected to each other via a hollow pipe, such that water is supplied using a water supply gun at the platform of the subway station.

6. The spray device of claim 1, wherein the spray device has a water supply port at one side thereof, and the water supply port has a water supply port cover, the water supply port cover has a hollow portion from a central portion of a contact surface which closely adjoins the water support port to a downward protruding end, wherein a level sensor which detects a water level inside the water tank interworks with the control panel when the water is being supplied, so that, when the water supplied inside the water supply tank is equal to or higher than a high-water level, a buzzer operates and a portion of the water that is at or higher than the high-water level is discharged to an outside via the hollow portion of the water supply port cover.

7. The spray device of claim 1, wherein the spray device has a heater unit therein and a heat-retaining insulation material covering an outer portion thereof, heat-generating elements are provided on outer portions of the distribution pipes and are covered with the heat-retaining insulation material and a heat-retaining insulation material cover.
